(19) United States
(12) Patent Application Publication
(10) Pub. No.: US 2006/0246903 A1
(43) Pub. Date: Nov. 2, 2006

(54) System and method for voice data handoff between cellular network and WiBro/WLAN network in heterogeneous network environment

(75) Inventors: Dong-Keon Kong, Suwon-si (KR); Hye-Won Baek, Seongnam-si (KR); Ji-Cheol Lee, Yongin-si (KR); Jae-Woo Kwon, Suwon-si (KR); Sang-Jun Moon, Yongin-si (KR); Jong-Bum Pyo, Yongin-si (KR); Heung-Chul Jung, Suwon-si (KR); Eun-Young Chung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/413,195

(22) Filed: Apr. 28, 2006

(30) Foreign Application Priority Data
Apr. 29, 2005 (KR) 2005-36406
Apr. 29, 2005 (KR) 2005-36408

(51) Int. Cl. H04Q 7/20; H04M 1/00

(52) U.S. Cl. 455/437; 455/436; 455/552.1

(57) ABSTRACT

A system and method are provided for performing voice data handoff from a cellular network to a portable Internet/wireless local area network (WLAN) network by a mobile terminal in a heterogeneous network environment. The system and method are provided wherein whether to perform handoff is determined, and a location of a mobile terminal in the portable Internet/WLAN network is registered, a request for handoff is sent to the cellular network, and in response thereto, a request for voice-over-Internet protocol (VoIP) call setup through a specific upper node of the portable Internet/WLAN network is received, and the VoIP call to the upper node of the portable Internet/WLAN network is set-up, and resources of a circuit voice call to a specific upper node of the cellular network are released.

### CROSS-REFERENCE TO RELATED APPLICATIONS

This application claims the benefit under 35 U.S.C. § 119(a) of application Serial No. 2005-36406, filed in the Korean Intellectual Property Office on Apr. 29, 2005 and application Serial No. 2005-36408, filed in the Korean Intellectual Property Office on Apr. 29, 2005, the entire disclosures of both of which are hereby incorporated by reference.

### BACKGROUND OF THE INVENTION

1. Field of the Invention

The present invention relates generally to a system and method for voice data handoff between a cellular network and a WiBro/WLAN network in a heterogeneous network environment. More particularly, the present invention relates to a system and method which seamlessly provide a 3rd generation (3G) voice service to a mobile terminal while it moves between a cellular network and a Wireless Broadband (WiBro, also known as “Portable Internet”) network or a wireless local area network (WLAN) in an Internet protocol Multimedia Subsystem (IMS)-based heterogeneous network environment.

2. Description of the Related Art

In the following description, the heterogeneous networks include a cellular network (CDMA 2000 1X system) and a WiBro network, by way of example. IMS in the cellular network is a core technology for providing users with ubiquitous services, such as wire/wireless integrated service, voice/data integrated service, and communication/broadcasting convergence service, in a broadband integrated network. IMS users can exchange with each other multimedia contents, such as pictures, video clips, and sound clips, through session-based messages. For example, the session-based message includes a Session Initiation Protocol (SIP) message.

The major functional elements of a core network subsystem for MBS service include a Call Session Control Function (CSCF), a Home Subscriber Server (HSS), a Media Gateway Control Function (MGCF), and an IMS-Media Gateway (IMS-MGW). The CSCF performs a call and session processing-related function, and is classified into a Proxy CSCF (P-CSCF), an Integrating CSCF (I-CSCF), and a Serving CSCF (S-CSCF) according to its function.

The P-CSCF is an element for performing a gateway function when a terminal first accesses the network to receive MBS service, and performs a Proxy and User Agent function. Basically, the P-CSCF replays SIP messages between the terminal and the network. The I-CSCF serves as a contact point for all calls incoming to connect with subscribers in the network, and inquires of an HSS for location detection of a called subscriber before routing a call. In addition, the I-CSCF, as it serves as a gateway with another IMS network, also serves as a firewall for hiding a topology in the network for security.

The S-CSCF performs, during its registration, a Register function and various authentication functions necessary therefor. The S-CSCF performs a series of mechanisms for directly interworking with application servers to provide various multimedia services, routing a call based on triggering information, and providing services.

The MGCF, located in the contact point between an IMS network and a Public Switch Telephone Network/Plain Land Mobile Network (PSTN/PLMN) network, takes charge of interworking a call, and performs an SIP and ISDN User Part (ISUP) signaling protocol translation function according thereto. The MGCF performs a function of managing and controlling resources in the IMS-MGW for call processing.

The IMS-MGW, an MGW used in the IMS network, performs a function of converting IP packet media data into the format that can be transmitted on a bearer of a circuit switched network in order to interwork with the PSTN/PLMN network, and performs such functions as transcoding and echo canceling, for that purpose.

The HSS, an evolved type of the conventional Home Location Register (HLR), is an addition of an Authentication Center (AuC) function to the conventional HLR function. The HSS is a subscriber's master database for managing user number-related information, location information, and service profile information.

Meanwhile, the core functional elements of the WiBro network include a Radio Access Station (RAS) and an Access Control Router (ACR). The RAS provides a wireless access function, a wireless resource management and control function, and a handoff support function of Portable Internet (WiBro). The ACR provides IP routing and mobility management functions.

The issue in the foregoing vertical handoff (or handoff between heterogeneous networks) process is a handoff time and a packet loss caused by the handoff. Therefore, an efficient interworking scheme between the heterogeneous networks should be able to minimize the handoff time and the packet loss. However, there has been no standard defined for the handoff procedure necessary for the case where a user receiving voice service in a heterogeneous network environment moves from the cellular network to the WiBro/WLAN network, making it impossible to perform fast handoff between the heterogeneous networks.

Accordingly, there is a need for an improved system and method for voice data handoff between a cellular network and a WiBro/WLAN network in a heterogeneous network environment.

### SUMMARY OF THE INVENTION

Exemplary embodiments of the present invention address at least the above problems and/or disadvantages and provide at least the advantages described below. It is, therefore, an exemplary object of the present invention to provide a system and method which provide seamless voice service when a mobile terminal moves between cellular coverage and Portable Internet (WiBro) coverage in a heterogeneous network environment.

According to an exemplary aspect of the present invention, a system and method are provided for performing voice data handoff from a cellular network to a portable Internet/wireless local area network (WLAN) network by a mobile terminal in a heterogeneous network environment. The system and method are provided wherein, whether to perform handoff of the mobile terminal is determined and a location of the terminal in the portable Internet/WLAN network is registered, a request for handoff to the cellular network is sent, and in response thereto a request for voice-over-Internet protocol (VoIP) call setup through a specific upper node of the portable Internet/WLAN network is received, and the VoIP call to the upper node of the portable Internet/WLAN network is set up, and resources of a circuit voice call to a specific upper node of the cellular network are released.

According to another exemplary aspect of the present invention, there are provided a system and method for performing voice data handoff to a cellular network by a first mobile terminal among the first mobile terminal located in a portable Internet/wireless local area network (WLAN) network and a second mobile terminal located in the portable Internet/WLAN network or the cellular network in a heterogeneous network environment. The system and method are provided in which the first mobile terminal determines whether it has entered the cellular network and its location in the cellular network according to the determination result is registered, the first mobile terminal sends a request for handoff to a specific upper node of the portable Internet/WLAN network, and the upper node of the portable Internet/WLAN network sets up a circuit voice call of the first mobile terminal to the cellular network through a specific upper node of the cellular network.

### BRIEF DESCRIPTION OF THE DRAWINGS

The above and other objects, features and advantages of the exemplary embodiments of the present invention will become more apparent from the following detailed description when taken in conjunction with the accompanying drawings in which:

FIG. 1 is a diagram illustrating network architecture for providing seamless 3G voice service in a cellular network and a WiBro network according to an exemplary embodiment of the present invention;

FIG. 2 is a diagram illustrating a scenario in which a first mobile terminal (MT1) located in a cellular network attempts handoff to a WiBro network while performing a voice call with a second mobile terminal (MT2) also located in a cellular network according to a first exemplary embodiment of the present invention;

FIG. 3 is a call flow diagram in which an MT1 performs handoff from a cellular network to a WiBro network in the scenario of FIG. 2 according to the first exemplary embodiment of the present invention;

FIGS. 4A and 4B are diagrams illustrating voice data paths before and after an MT1 performs handoff according to the first exemplary embodiment of the present invention;

FIG. 5 is a diagram illustrating a scenario in which an MT1 located in a cellular network attempts handoff to a WiBro network while performing a voice call with an MT2 located in the WiBro network according to a second exemplary embodiment of the present invention;

FIG. 6 is a call flow diagram in which an MT1 performs handoff from a cellular network to a WiBro network in the scenario of FIG. 5 according to the second exemplary embodiment of the present invention;

FIGS. 7A and 7B are diagrams illustrating voice data paths before and after an MT2 performs handoff according to the second exemplary embodiment of the present invention;

FIG. 8 is a diagram illustrating a scenario in which an MT1 located in a WiBro network performs handoff to a cellular network while performing a voice call with an MT2 also located in the WiBro network according to a third exemplary embodiment of the present invention;

FIG. 9 is a call flow diagram in which an MT1 performs handoff from a WiBro network to a cellular network in the scenario of FIG. 8 according the third exemplary embodiment of the present invention;

FIGS. 10A and 10B are diagrams illustrating voice data paths before and after an MT2 performs handoff according to the third exemplary embodiment of the present invention;

FIG. 11 is a diagram illustrating a scenario in which an MT1 located in a WiBro network attempts handoff to a cellular network while performing a voice call with an MT2 located in the cellular network according to a fourth exemplary embodiment of the present invention;

FIG. 12 is a call flow diagram in which an MT1 performs handoff from a WiBro network to a cellular network in the scenario of FIG. 11 according to the fourth exemplary embodiment of the present invention; and

FIGS. 13A and 13B are diagrams illustrating voice data paths before and after an MT1 performs handoff according to the fourth exemplary embodiment of the present invention.

### DETAILED DESCRIPTION OF EXEMPLARY EMBODIMENTS

Several exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

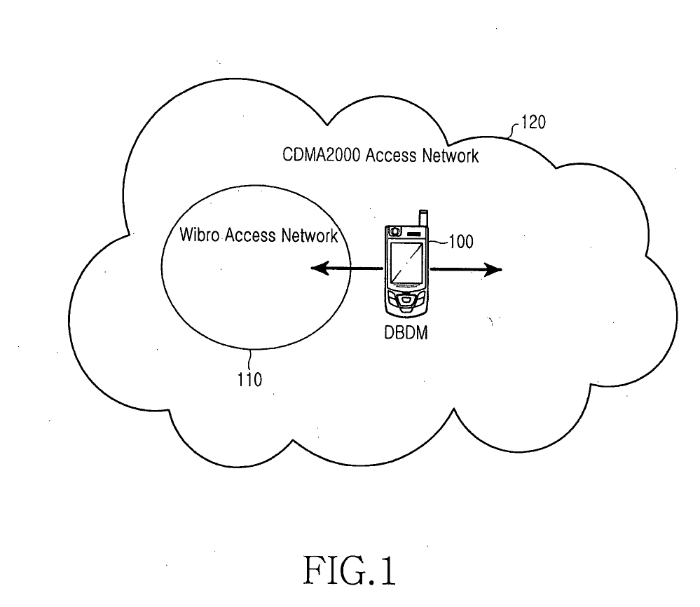

FIG. 1 is a diagram illustrating network architecture for providing seamless 3G voice service in a cellular network and a WiBro network according to an exemplary embodiment of the present invention.

Referring to FIG. 1, a WiBro (or Portable Internet) network 110 is deployed in a specific area of a cellular network 120, forming a complementary relationship. Therefore, a dual-band, dual-mode (DBDM) mobile terminal 100, when it enters a particular hot spot (WiBro coverage) while in 3G service, can receive WiBro service. Cells of the WiBro network 110 and the cellular network 120 may have either an overlapping configuration supporting services of both networks, or a separate configuration supporting only service of any one of the networks. The detailed technical characteristics of the cells are not directly related to the present invention, so a detailed description thereof will be omitted.

The DBDM mobile terminal and a Base Station System (BSS) of the cellular network according to an exemplary embodiment of the present invention have the following requirements.

The DBDM mobile terminal, in cellular coverage, receives information indicating the presence or absence of a WiBro cell through an overhead message. The DBDM transmits a Pilot Strength Measurement Message (PSMM) to the BSS of the cellular network if signal strength of a Pseudo Noise (PN) value from a cellular base station overlapping with a WiBro base station exceeds a threshold. Upon recognizing the presence of the WiBro cell, the DBDM terminal activates a WiBro modem. The DBDM terminal, after activating the WiBro modem, registers at the WiBro network and performs location registration (WiBro-CDMA dual-activated state) in an IMS network.

The BSS of the cellular network manages a cellular-WiBro cell overlapping area with a neighbor list. The BSS inserts an indicator in an overhead message and sends the overhead message to the DBDM mobile terminal in order to indicate the presence of the WiBro cell. If a PN sequence transmitted by the DBDM mobile terminal is a cell identifier (ID) of the cellular-WiBro cell overlapping area, a request for hard handoff is sent to a Mobile Switching Center (MSC).

### First Exemplary Embodiment

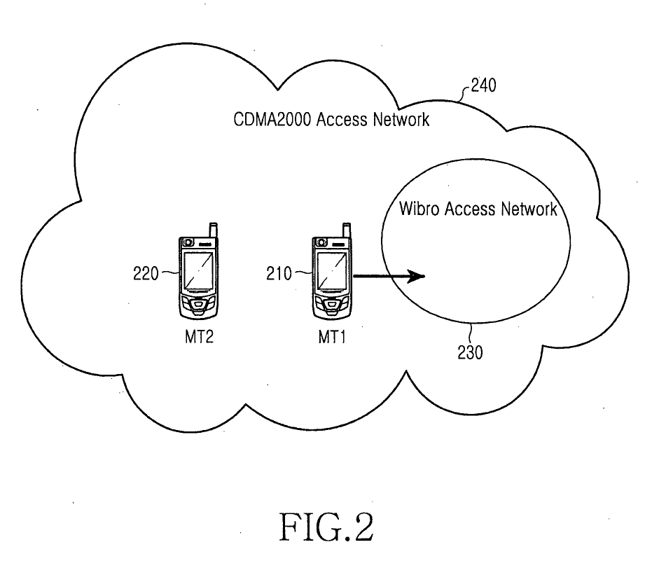

FIG. 2 is a diagram illustrating a scenario in which a first mobile terminal (MT1) located in a cellular network attempts handoff to a WiBro network while performing a voice call with a second mobile terminal (MT2) also located in a cellular network according to a first exemplary embodiment of the present invention

In the first exemplary embodiment, described with reference to FIG. 2, a first DBDM mobile terminal (MT1) 210 and a second DBDM mobile terminal (MT2) 220 are performing a 3G circuit call with each other in a cellular network 240 and the MT1 210 is moving from the cellular network 240 to enter a WiBro network 230. Also in the first exemplary embodiment, the WiBro network 230 is deployed such that cells of the WiBro network 230 overlap cells of the cellular network 240. In the cellular-only coverage, if a DBDM mobile terminal monitors both of the cellular wireless section and the WiBro wireless section, its battery consumption increases. In this exemplary embodiment, the mobile terminal does not operate in a WiBro mode to save its battery power. The BSS of the cellular network sends information indicating the presence or absence of a WiBro cell to the DBDM mobile terminal through an overhead message. For example, the BSS may modify the existing field (MSB bits of Packet Zone ID) in a system parameter message, or add a separate field in the message.

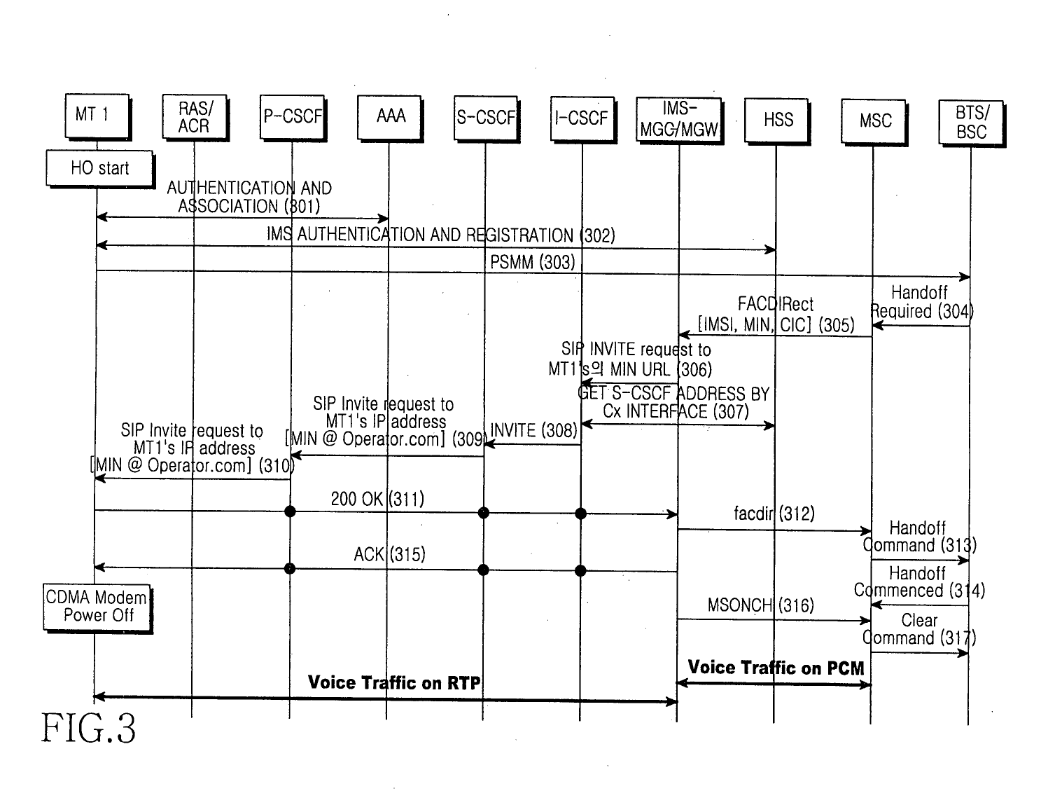

FIG. 3 is a call flow diagram in which an MT1 performs handoff from a cellular network to a WiBro network in the scenario of FIG. 2 according to the first exemplary embodiment of the present invention. The messages shown in FIG. 3 are defined in the 3rd Generation Partnership Project (3GPP) standard, so a detailed description thereof will be omitted.

Referring to FIG. 3, in steps 301 and 302, an MT1 enables a WiBro modem upon receiving an overhead message with information indicating the presence of a WiBro coverage (cell) in a cellular coverage (cell). If received strength of a WiBro signal is higher than or equal to a threshold for a time period, the MT1 determines handoff, considering that it is moving to the WiBro coverage. The MT1 performs Layer 3 (L3) Attachment to WiBro, and performs an IMS registration procedure defined in the IMS standard. In step 303, the MT1 transmits a PSMM with the received signal strength to a Base Station System (BTS/BSC) or a Radio Access Network (RAN).

In step 304, the BTS/BSC transmits a Handoff Required message to an MSC. In step 305, the MSC transmits a FacilitiesDirective (FACDIR) message indicating a start of a handoff procedure to an MGC of an IMS network if a target Cell ID included in the Handoff Required message overlaps with the WiBro cell. Upon receiving the FACDIR message, the MGC selects a channel and determines available media capacity through communication with an IMS-MGW.

In step 306, the MGC uses a Mobile Identification Number (MIN) of the MT1 as an SIP Uniform Resource Locator (URL), and delivers the MIN and an ESN of the MT1 to an I-CSCF along with an SIP INVITE message. In step 307, the I-CSCF queries an HSS about an address of an S-CSCF that takes charge of a session of an MT2, and receives an address of the S-CSCF from the HSS. In step 308, the I-CSCF transmits an INVITE message to the S-CSCF. The S-CSCF determines whether this session setup is appropriate. In steps 309 and 310, the INVITE message is delivered to the MT1 via a P-CSCF. At this moment, the MT1 recognizes an IP and a port number of an MGW, included in an SDP.

In step 311, the MT1 transmits an SIP 2000K message indicating connection of a voice call, to the MGC. In step 312, the MGC delivers a FACDIR message to the MSC because a Voice-over-IP (VoIP) session to the handoff requiring MT1 is set up. In steps 313 and 314, the MSC receiving the FACDIR message exchanges Handoff Command/Handoff Commenced messages defined in the International Organization for Standardization (IOS) standard with the source BTS/BSC. However, the 3G BTS/BSC may not transmit a Handoff Direction message to the MT1 and may include a Proprietary Field in the Handoff Command message in order to simulate as if it transmitted the Handoff Direction message to the MT1. In step 315, the MGC transmits an ACK message to the MT1.

In step 316, if a channel to the MT1 and a voice path between the MSC and the trunk are completely set up, the MGC transmits an MSONCH message to the MSC. In step 317, the MSC transmits a Clear Command message to the BTS/BSC to request release of resources for the corresponding call.

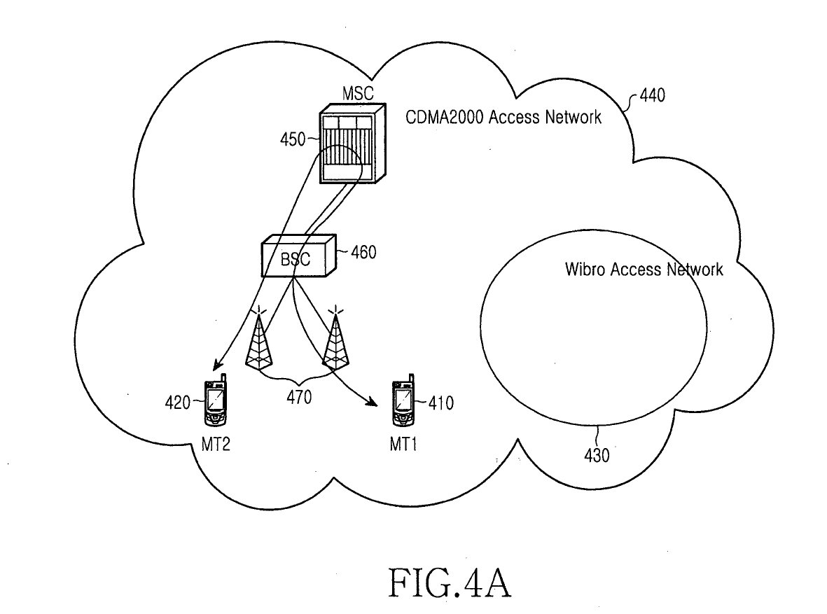

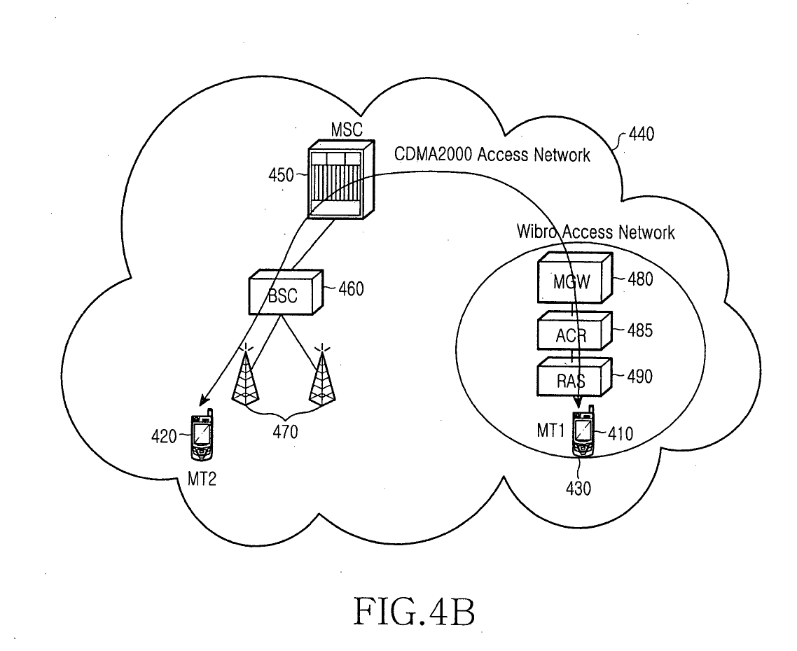

FIGS. 4A and 4B are diagrams illustrating voice data paths before and after an MT1 performs handoff according to the first exemplary embodiment of the present invention.

Referring to FIG. 4A, before an MT1 410 performs handoff to a WiBro network 430, both the MT1 410 and an MT2 420 are located in a cellular network 440. For example, a voice data path between the MT1 410 and the MT2 420 may be set up through a Base station Transceiver Subsystem (BTS) 470, a Base Station Controller (BSC) 460 and an MSC 450, located in the cellular network 440. The set voice data path changes to a voice data path shown in FIG. 4B after handoff. Referring to FIG. 4B, after the MT1 410 performs handoff to the WiBro network 430, a voice data path between the MT1 410 and the MT2 420 may of pass through the cellular network 440 and the WiBro network 430. For example, the voice data path between the MT1 410 and the MT2 420 may be established such that it sequentially passes through a RAS 490, an ACR 485 and an MGW 480, the elements of the WiBro network 430, starting from the MT1 410, and then passes again through the MSC 450, the BSC 460, the BTS 470, and the MT2 420, the elements of the cellular network 440.

### Second Exemplary Embodiment

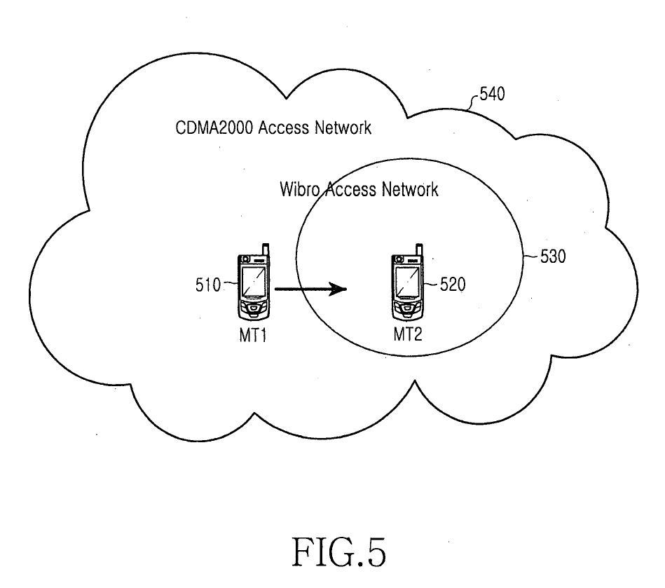

FIG. 5 is a diagram illustrating a scenario in which an MT1 located in a cellular network attempts handoff to a WiBro network while performing a voice call with an MT2 located in the WiBro network according to a second exemplary embodiment of the present invention. In this exemplary embodiment, the cellular network and the WiBro network have the same service provider.

In the exemplary embodiment described with reference to FIG. 5, a DBDM MT1 510 is located in a cellular network 540 and an MT2 520 is located in a WiBro network 530, performing a call between heterogeneous networks, and the MT1 510 is moving from the cellular network 540 to enter the WiBro network 530. Also in the exemplary embodiment, the WiBro network 530 is deployed such that cells of the WiBro network 530 overlap cells of the cellular network 540. In the cellular-only coverage, if a DBDM mobile terminal monitors both of the cellular wireless section and the WiBro wireless section, its battery consumption increases. In this exemplary embodiment, the mobile terminal does not operate in a WiBro mode to save its battery power. The BSS of the cellular network sends information indicating the presence or absence of a WiBro cell to the DBDM mobile terminal through an overhead message. For example, the BSS may modify the existing field (MSB bits of Packet Zone ID) in a system parameter message, or add a separate field in the message.

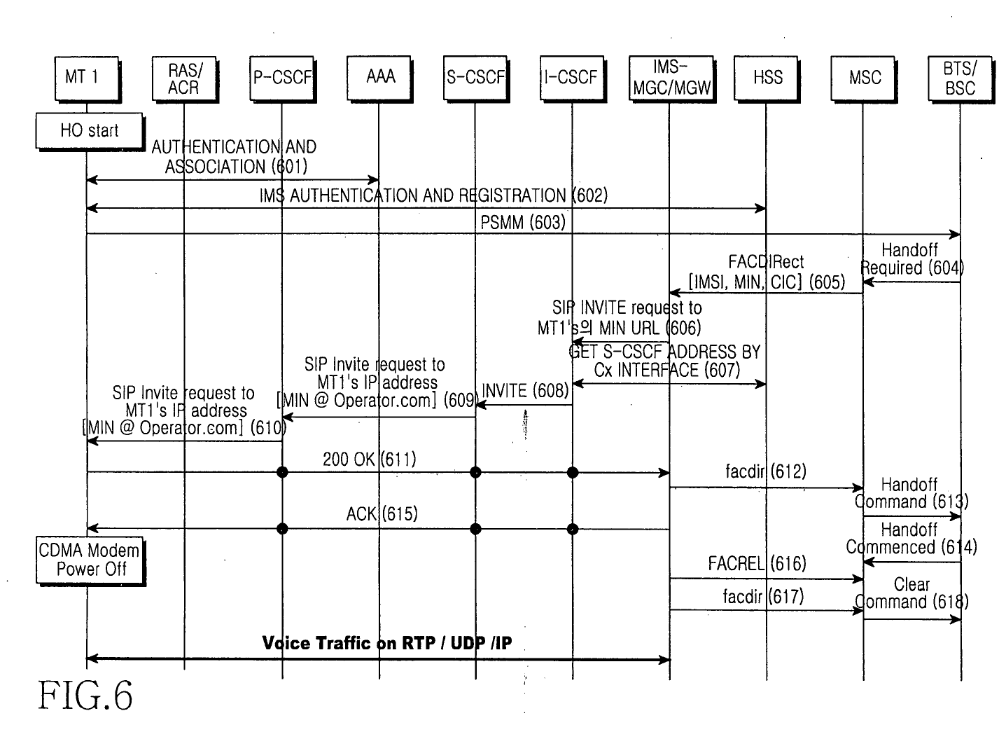

FIG. 6 is a call flow diagram in which an MT1 performs handoff from a cellular network to a WiBro network in the scenario of FIG. 5 according to the second exemplary embodiment of the present invention. In this exemplary embodiment, an MT1 and an MT2 set up their session through the same MGC. An MGC and an MSC release the traffic path setup, and voice traffics are delivered through the same MGW. The messages shown in FIG. 6 are defined in the 3GPP standard, so a detailed description thereof will be omitted.

Referring to FIG. 6, in steps 601 and 602, an MT1 enables a WiBro modem upon receiving an overhead message with information indicating the presence of a WiBro coverage (cell) in a cellular coverage (cell). If received strength of a WiBro signal is higher than or equal to a threshold for a time period, the MT1 determines handoff, considering that it is moving to the WiBro coverage. The MT1 performs L3 Attachment to WiBro, and performs an IMS registration procedure defined in the IMS standard. In step 603, the MT1 transmits a PSMM with the received signal strength to a BTS/BSC, or a Radio Access Network (RAN).

In step 604, the BTS/BSC transmits a Handoff Required message to an MSC of the cellular network. In step 605, the MSC transmits a FacilitiesDirective (FACDIR) message indicating a start of a handoff procedure to an MGC of an IMS network if a target Cell ID included in the Handoff Required message overlaps with the WiBro cell. Upon receiving the FACDIR message, the MGC selects a channel and determines available media capacity through communication with an IMS-MGW.

In step 606, the MGC uses a MIN of the MT1 as an SIP URL, and delivers the MIN and an ESN of the MT1 to an I-CSCF along with an SIP INVITE message. In step 607, the I-CSCF queries an HSS about an address of an S-CSCF that takes charge of a session of an MT2, and receives an address of the S-CSCF from the HSS. In step 608, the I-CSCF transmits an INVITE message to the S-CSCF. The S-CSCF determines whether this session setup is appropriate. In steps 609 and 610, the INVITE message is delivered to the MT1 via a P-CSCF. At this moment, the MT1 recognizes an IP and a port number of an MGW, included in an SDP.

In step 611, the MT1 transmits an SIP 2000K message indicating connection of a voice call, to the MGC. In step 612, the MGC delivers a FACDIR message to the MSC because a VoIP session to the handoff requiring MT1 is set up. In steps 613 and 614, the MSC receiving the FACDIR message exchanges Handoff Command/Handoff Commenced messages defined in the IOS standard with the source BTS/BSC. However, the 3G BTS/BSC may not transmit a Handoff Direction message to the MT1, and may include a Proprietary Field in the Handoff Command message in order to simulate as if it transmitted the Handoff Direction message to the MT1. In step 615, the MGC transmits an ACK message to the MT1.

In step 616, the MGC transmits a FacilitiesRelease (FACREL) message to the MSC in order to request release of the trunk to the MSC. In step 617, upon receiving the FACREL message, the MSC changes the trunk into an idle state through communication with the MGW, and responds to the FACREL message. In step 618, the MSC transmits a Clear Command message to the BTS/BSC to request release of resources for the corresponding call.

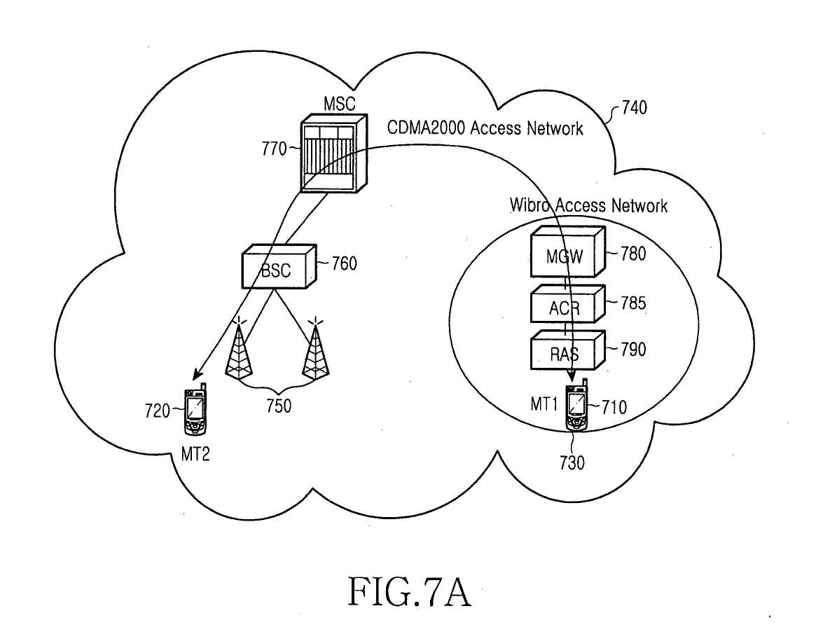

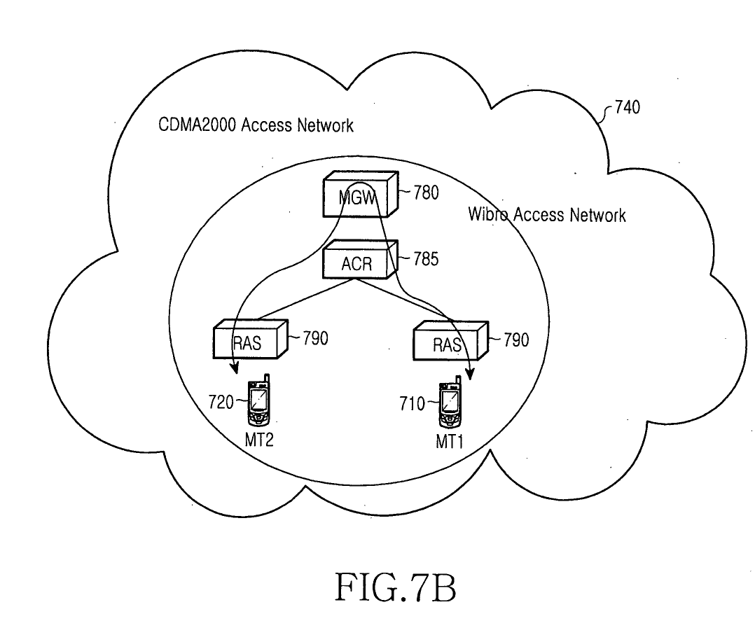

FIGS. 7A and 7B are diagrams illustrating voice data paths before and after an MT2 performs handoff according to the second exemplary embodiment of the present invention.

Referring to FIG. 7A, before an MT2 720 performs handoff to a WiBro network 730, a voice data path between an MT1 710 and the MT2 720 may pass through a cellular network 740 and a WiBro network 730. For example, the voice data path between the MT1 710 and the MT2 720 may be established such that it sequentially passes through a RAS 790, an ACR 785 and an MGW 780, the elements of the WiBro network 730, starting from the MT1 710, and then passes again through the MSC 770, the BSC 760, the BTS 750, and the MT2 720, the elements of the cellular network 740. The set voice data path changes to a voice data path shown in FIG. 7B after handoff.

Referring to FIG. 7B, after the MT2 performs handoff to the WiBro network 730, both the MT1 710 and the MT2 720 are located in the WiBro network 730. For example, the voice data path between the MT1 710 and the MT2 720 may be established through the ACR 785 and the RASs 790, using the MGW 780 located in the WiBro network 730 as the vertex.

### Third Exemplary Embodiment

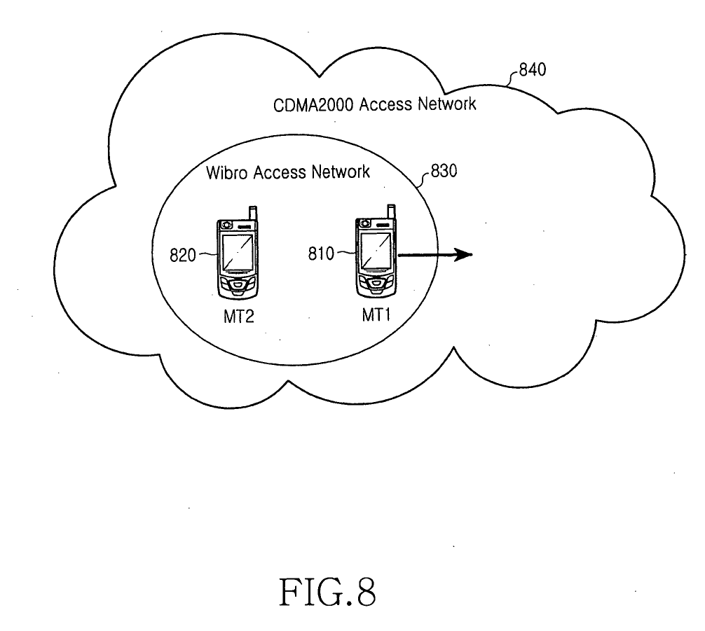

FIG. 8 is a diagram illustrating a scenario in which an MT1 located in a WiBro network performs handoff to a cellular network while performing a voice call with an MT2 also located in the WiBro network according to a third exemplary embodiment of the present invention.

In the third exemplary embodiment, described with reference to FIG. 8, a first DBDM mobile terminal (MT1) 810 and a second DBDM mobile terminal (MT2) 820 are performing a VoIP call with each other in a WiBro network 830 and the MT1 810 is moving from the WiBro network 830 to enter a cellular network 840. Also in the third exemplary embodiment, the WiBro network 830 is deployed such that cells of the WiBro network 830 overlap cells of the cellular network 840. If received strength of a WiBro signal is lower than or equal to a threshold, the MT1 enables a CDMA modem to receive CDMA information. If there is no indicator indicating the presence of a WiBro cell in the received CDMA overhead message, the MT1 enters the cellular-only coverage.

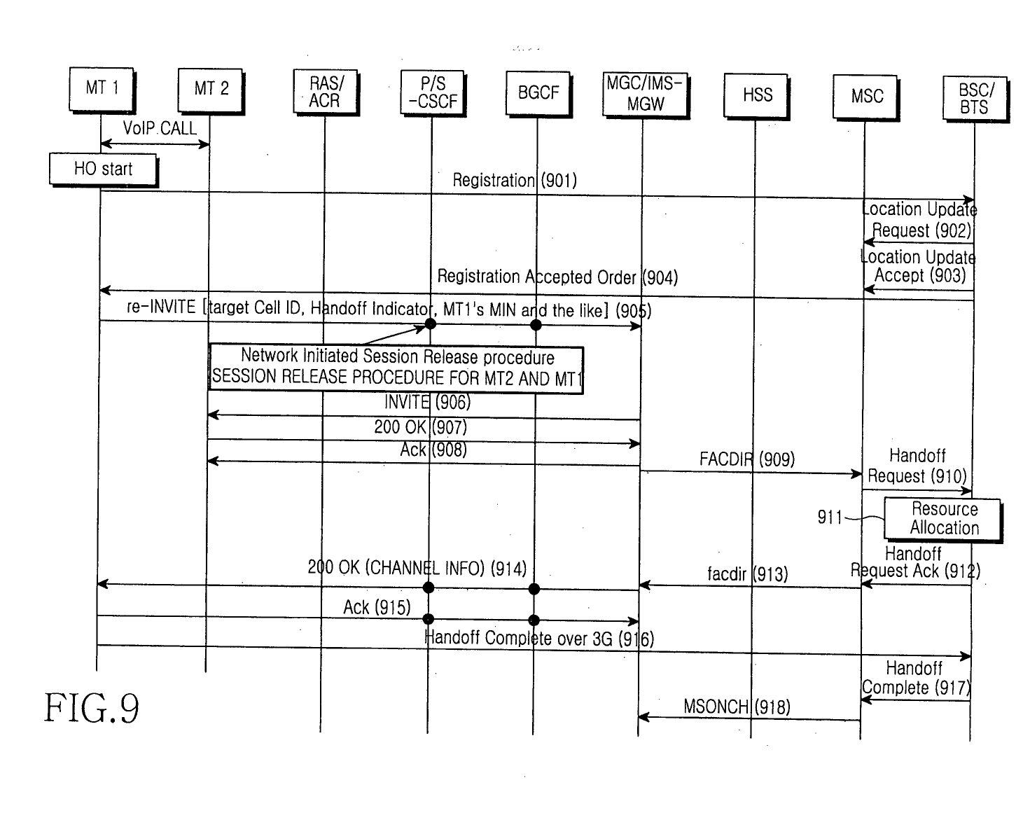

FIG. 9 is a call flow diagram in which an MT1 performs handoff from a WiBro network to a cellular network in the scenario of FIG. 8 according the third exemplary embodiment of the present invention. The messages shown in FIG. 9 are defined in the 3GPP standard, so a detailed description thereof will be omitted.

Referring to FIG. 9, in steps 901 to 904, if received strength of a WLAN/WiBro signal is lower than or equal to a predetermined threshold for a time period, an MT1 enables a CDMA modem, determining that it is moving to a cellular network. The MT1 performs location registration in the cellular network in the dual-activated state.

In step 905, the MT1 transmits a re-INVITE message for the current VoIP SIP session. The re-INVITE message has a Session ID of the current session, a Target Cell ID, and an Indicator indicating the ongoing handoff to the cellular network, all of which are included in a predetermined field of its Body. A P-CSCF performs a Network Initiated Session Release procedure for the MT1 and the MT2, upon receiving a re-INVITE Request message with a handoff indicator.

In steps 906 to 908, upon receiving the re-INVITE Request message, an MGC sets up a new session to the MT2.

In step 909, the MGC transmits a FACDIR message indicating a start of a handoff procedure to an MSC of a target cell ID network. In steps 910 to 912, upon receiving the FACDIR message, the MSC transmits a Handoff Request message to a target BSC. After allocating resources of a target BTS, the target BSC transmits a response message to a target MSC in response to the handoff request. In step 913, the MSC transmits a FACDIR message to the MGC to notify its completed preparation for the handoff. In this case, the MSC transmits channel information of the target cell together.

In step 914, upon receiving the FACDIR message, the MGC transmits a 200 OK message indicating a start of handoff to the MT1 along with the channel information. In step 915, the MT1 transmits an ACK message in response to the 2000K message.

In step 916, the MT1 performs handoff to the cellular network using the channel information, and transmits a message indicating completion of the handoff procedure to the target BTS/BSC. In step 917, the target BSC delivers a message indicating completion of the handoff procedure to the target MSC. In step 918, the target MSC transmits a Mobile Station on Channel (MSONCH) message indicating completion of the voice path setup up to the mobile terminal to the MGC.

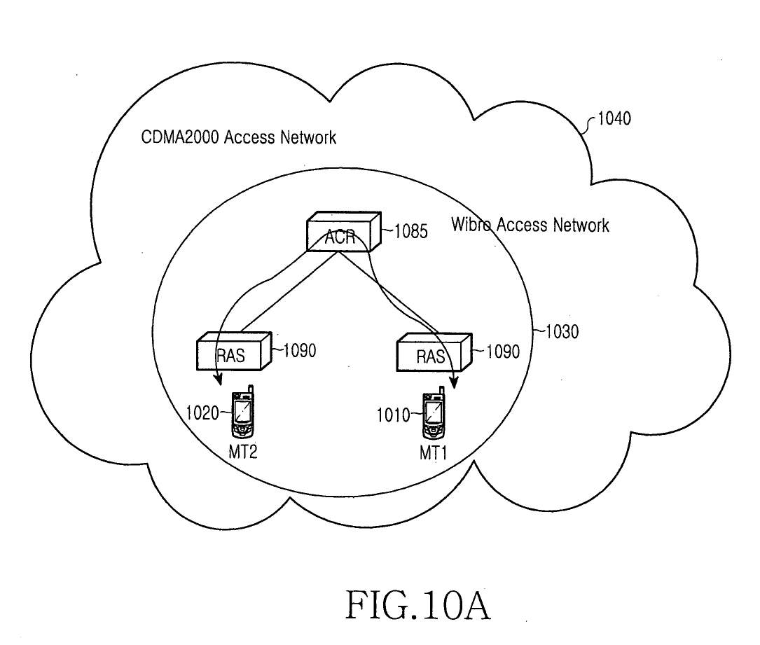

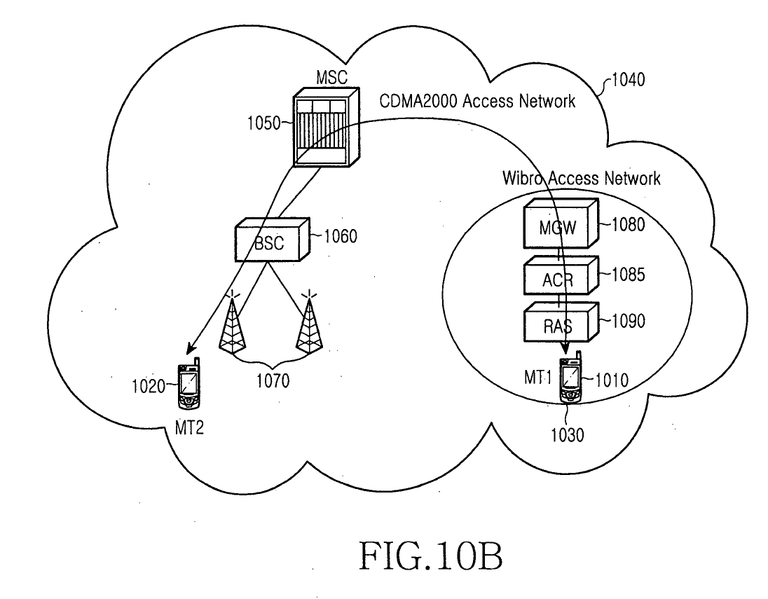

FIGS. 10A and 10B are diagrams illustrating voice data paths before and after an MT2 performs handoff according to the third exemplary embodiment of the present invention.

Referring to FIG. 10A, before an MT2 1020 performs handoff to a cellular network 1040, both an MT1 1010 and the MT2 1020 are located in a WiBro network 1030. For example, a voice data path between the MT1 1010 and the MT2 1020 may be set up through a RAS 1090 and an ACR 1085 located in the WiBro network 1030. The set voice data path changes to a voice data path shown in FIG. 4B after handoff.

Referring to FIG. 10B, after the MT2 1020 performs handoff to the cellular network 1040, the voice data path between the MT1 1010 and the MT2 1020 assumes the form of passing through the cellular network 1040 and the WiBro network 1030. For example, the voice data path between the MT1 010 and the MT2 1020 may be established such that it sequentially passes through a RAS 1090, an ACR 1085 and an MGW 1080, the elements of the WiBro network 1030, starting from the MT1 1010 located in the WiBro network 1030, and then passes again through an MSC 1050, a BSC 1060, a BTS 1070, and the MT2 1020, the elements of the cellular network 1040.

### Fourth Exemplary Embodiment

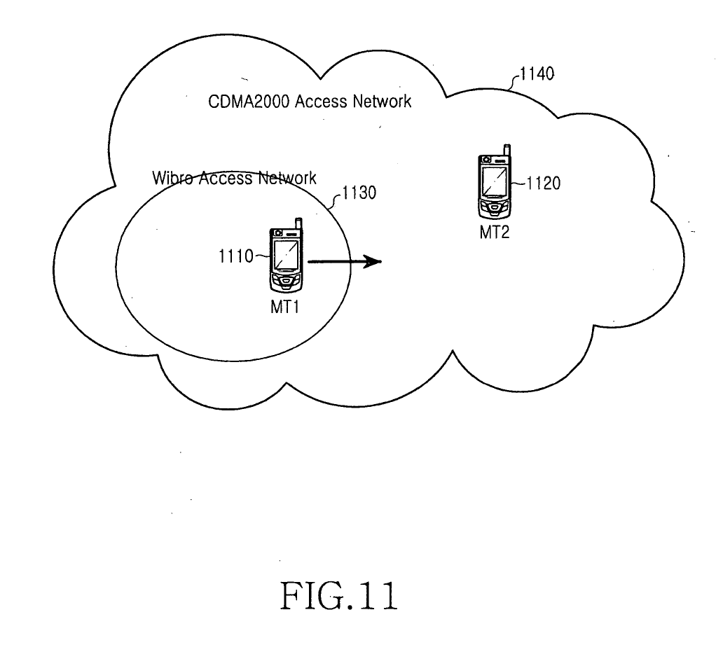

FIG. 11 is a diagram illustrating a scenario in which an MT1 located in a WiBro network attempts handoff to a cellular network while performing a voice call with an MT2 located in the cellular network according to a fourth exemplary embodiment of the present invention. In the fourth exemplary embodiment, the cellular network and the WiBro network have the same service provider.

In the fourth exemplary embodiment, described with reference to FIG. 11, a DBDM MT1 1110 is located in a WiBro network 1130 and an MT2 1120 is located in a cellular network 1140, performing a call between heterogeneous networks, and the MT1 1110 is moving from the WiBro network 1130 to enter the cellular network 1140. Also in the fourth exemplary embodiment, the WiBro network 1130 is deployed such that cells of the WiBro network 1130 overlap cells of the cellular network 1140.

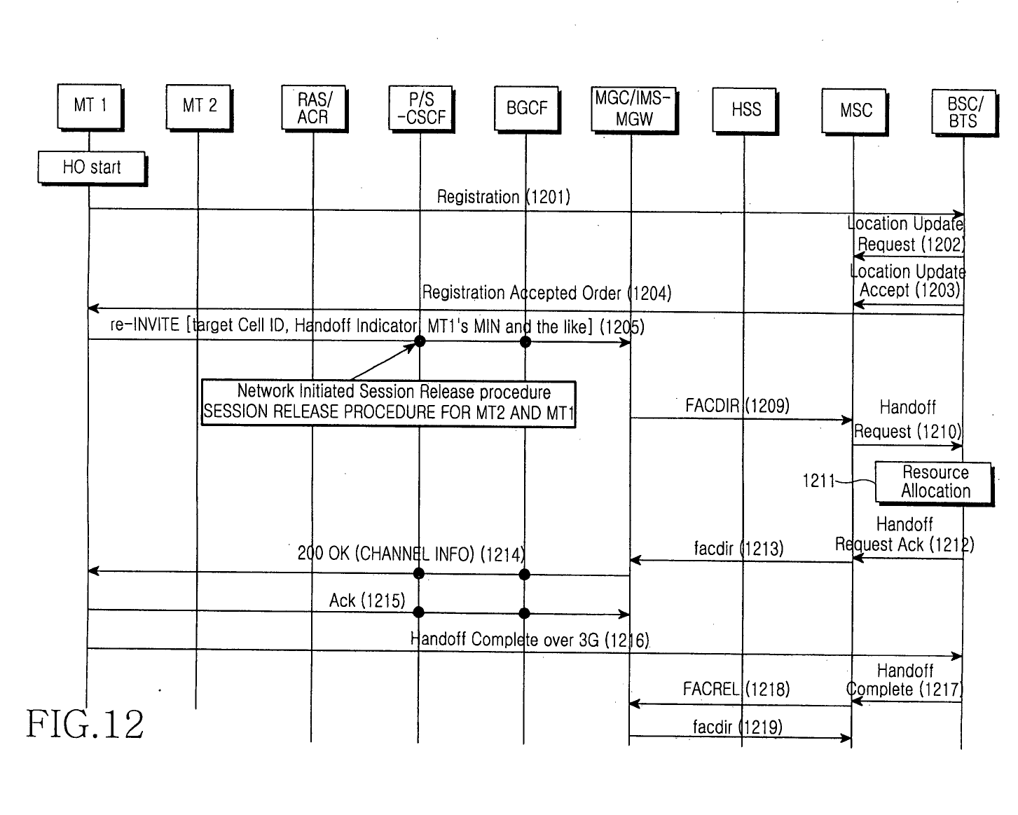

FIG. 12 is a call flow diagram in which an MT1 performs handoff from a WiBro network to a cellular network in the scenario of FIG. 11 according to the fourth exemplary embodiment of the present invention. The messages shown in FIG. 12 are defined in the 3GPP standard, so a detailed description thereof will be omitted.

Referring to FIG. 12, in steps 1201 to 1204, if received strength of a WLAN/WiBro signal is lower than or equal to a threshold for a time period, an MT1 enables a CDMA modem, determining that it is moving to a cellular network. The MT1 performs location registration in the cellular network in the dual-activated state.

In step 1205, the MT1 transmits a re-INVITE message for the current VoIP SIP session. The re-INVITE message has a Session ID of the current session, a Target Cell ID, and an Indicator indicating the ongoing handoff to the cellular network, all of which are included in a predetermined field of its Body. A P-CSCF performs a Network Initiated Session Release procedure for the MT1 and the MT2, upon receiving a re-INVITE Request message with a handoff indicator.

In step 1209, an MGC transmits a FACDIR message indicating a start of a handoff procedure to an MSC of a target Cell ID network.

In steps 1210 to 1212, upon receiving the FACDIR message, the MSC transmits a Handoff Request message to a target BSC. The target BSC allocates resources of a target BTS, and then transmits a response message to a target MSC in response to the handoff request.

In step 1213, the MSC transmits an FACDIR message to the MGC to indicate its completed preparation for the handoff. In this case, the MSC transmits channel information of the target cell together. In step 1214, upon receiving the FACDIR message, the MGC transmits a 2000K message indicating a start of handoff to the MT1 along with the channel information.

In step 1215, the MT1 transmits an ACK message in response to the 2000K message. In step 1216, the MT1 performs handoff to the cellular network using the channel information, and transmits a message indicating completion of the handoff procedure to the target BTS/BSC. In step 1217, the target BSC delivers a message indicating completion of the handoff procedure to the target MSC.

In step 1218, the target MSC transmits a FACREL message to the MGC to request release of the trunk to the MGC. In step 1219, upon receiving the FACREL message, the MGC changes the trunk into an idle state through communication with the MGW, and responds to the FACREL message.

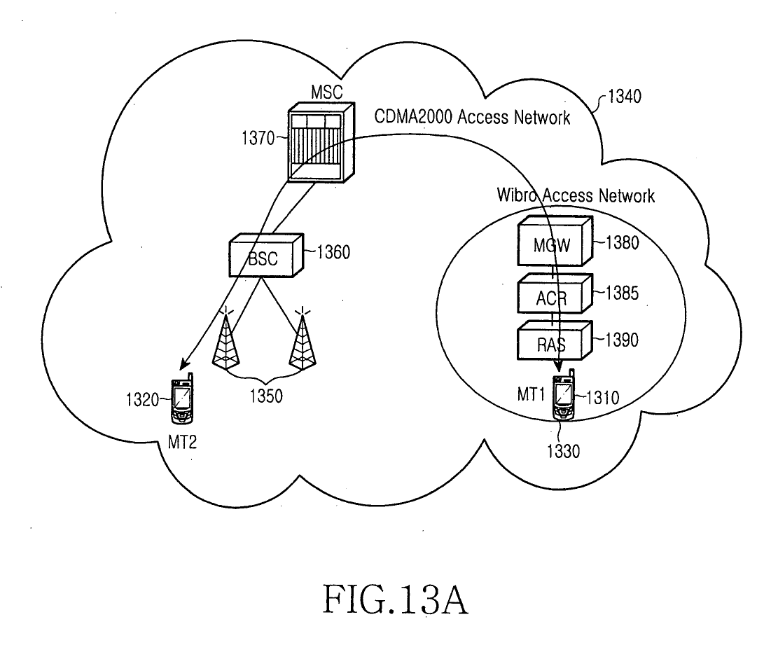

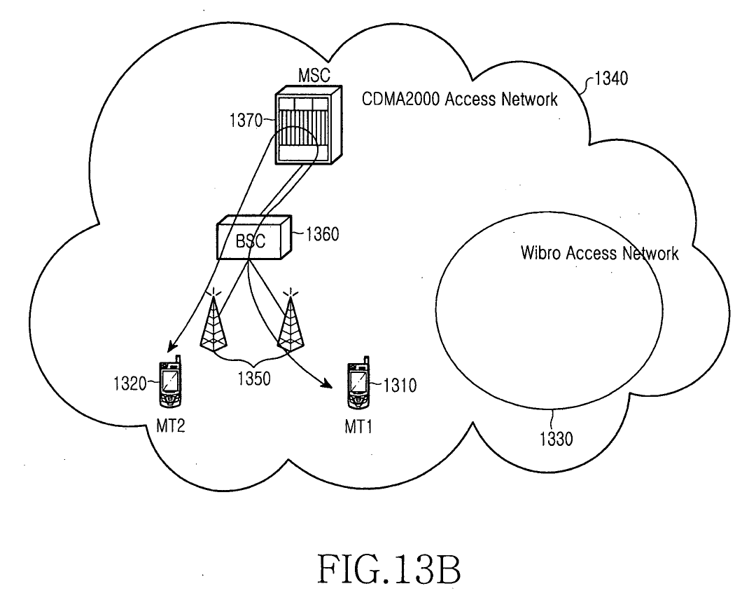

FIGS. 13A and 13B are diagrams illustrating voice data paths before and after an MT1 performs handoff according to the fourth exemplary embodiment of the present invention.

Referring to FIG. 13A, before an MT1 1310 performs handoff to a WiBro network 1330, a voice data path between the MT1 1310 and an MT2 1320 may pass through a cellular network 1340 and the WiBro network 1330. For example, the voice data path between the MT1 1310 and the MT2 1320 may be established such that it sequentially passes through a RAS 1390, an ACR 1385 and an MGW 1380, the elements of the WiBro network 1330, starting from the MT1 1310 located in the WiBro network 1330, and then passes again through an MSC 1370, a BSC 1360, a BTS 1350, and the MT2 1320, the elements of the cellular network 1340. The set voice data path changes to a voice data path shown in FIG. 13B after handoff.

Referring to FIG. 13B, after the MT1 1310 performs handoff to the cellular network 1340, both the MT1 1310 and the MT2 1320 are located in the cellular network 1340. For example, the voice data path between the MT1 1310 and the MT2 1320 may be established through the BSC 1360 and the BTS 1350, using the MSC 1370 located in the cellular network 1340 as the vertex.

As can be understood from the foregoing description, the exemplary embodiments of the present invention propose a system and method for fast handoff process between a cellular network and a Portable Internet (WiBro), thereby securing competitive one-phone service.

In addition, the exemplary embodiments of the present invention allow a circuit network service provider to simply launch wire/wireless integrated voice service.

Further, the exemplary embodiments of the present invention can serve as a catalytic technology for activating the wire/wireless integrated voice service.

While the invention has been shown and described with reference to a certain exemplary embodiment thereof, it will be understood by those skilled in the art that various changes in form and details may be made therein without departing from the spirit and scope of the invention as defined by the appended claims and the full scope of equivalents thereof.

What is claimed is:

1. A method for performing voice data handoff from a cellular network to a portable Internet/wireless local area network (WLAN), the method comprising the steps of:
(a) determining whether to perform handoff, and registering location of a mobile terminal in the portable Internet/WLAN network;
(b) requesting handoff from the cellular network, and in response thereto, receiving a request for voice-over-Internet protocol (VoIP) call setup through the portable Internet/WLAN network; and
(c) setting up the VoIP call to the portable Internet/WLAN network, and releasing resources of a circuit voice call to the cellular network.

2. The method of claim 1, wherein the step (a) comprises the steps of:
receiving, from the cellular network, information indicating presence/absence of a cell of the portable Internet/WLAN network; and
receiving a signal from a base station of the cellular network, wherein the base station overlaps a cell of the portable Internet/WLAN network; and
determining whether to perform handoff according to the signal strength.

3. The method of claim 2, wherein the information indicating presence/absence of a cell of the portable Internet/WLAN network is received from the base station of the cellular network through an overhead message.

4. The method of claim 3, wherein the overhead message comprises an indicator indicating presence/absence of a cell of the portable Internet/WLAN network.

5. The method of claim 2, wherein the mobile terminal enables a portable Internet/WLAN modem if there is a cell of the portable Internet/WLAN.

6. The method of claim 2, wherein the mobile terminal determines to perform the handoff if the strength of the signal received from the base station of the cellular network is higher than or equal to a threshold for a time period.

7. The method of claim 1, wherein the VoIP call setup is achieved through a specific upper node of the portable Internet/WLAN network using address information based on a mobile identification number (MIN) of the mobile terminal.

8. The method of claim 2, wherein the base station of the cellular network manages a cell of the cellular network and a cell of the portable Internet/WLAN network with a neighbor list.

9. The method of claim 1, wherein the mobile terminal disables a cellular modem, if the VoIP call is set up.

10. A method for performing voice data handoff to a cellular network by a mobile terminal, the method comprising the steps of:
determining by a first mobile terminal whether the first mobile terminal has entered a cellular network, and registering a location of the first mobile terminal in the cellular network according to the determination result;
sending, by the first mobile terminal, a request for handoff to the portable Internet/WLAN network; and
setting up, by the portable Internet/WLAN network, a circuit voice call of the first mobile terminal to the cellular network through the cellular network.

11. The method of claim 10, wherein the determining that the first mobile terminal has entered the cellular network comprises determining if strength of a signal received from the portable Internet/WLAN network is lower than a threshold for a time period.

12. The method of claim 10, wherein the first mobile terminal enables a cellular modem if the first mobile terminal enters the cellular network.

13. The method of claim 10, wherein the request for the handoff comprises releasing sessions between the first mobile terminal and a second mobile terminal.

14. The method of claim 13, wherein the handoff request for the handoff further comprises setting up a new session to the portable Internet/WLAN network by the second mobile terminal.

15. The method of claim 10, wherein the request for the handoff comprises transmitting, by the first mobile terminal, a predetermined message comprising at least one of a session identifier (ID), a target cell ID, and a handoff indicator.

16. The method of claim 10, wherein the setting up of the circuit voice call comprises transmitting a message comprising channel information of a base station of the cellular network, from an upper node of the portable Internet/WLAN network to the first mobile terminal.

17. The method of claim 10, wherein the first mobile terminal disables a portable Internet/WLAN modem, after setting up the circuit voice call to a base station of the cellular network.

18. The method of claim 1, wherein the step (b) comprises receiving a request for voice-over-Internet protocol (VoIP) call setup through a specific upper node of the portable Internet/WLAN network; and
wherein the step (c) comprises setting up the VoIP call to the upper node of the portable Internet/WLAN network, and releasing resources of a circuit voice call to a specific upper node of the cellular network.

19. The method of claim 10, wherein, the step of sending comprises sending, by the first mobile terminal, a request for handoff to a specific upper node of the portable Internet/WLAN network; and
the step of setting up comprises, setting up, by the upper node of the portable Internet/WLAN network, a circuit voice call of the first mobile terminal to the cellular network through a specific upper node of the cellular network.

20. A system for mobile terminal communication comprising:
a cellular network;
a portable Internet/wireless local area network (WLAN); and
a wireless terminal;
wherein the wireless terminal determines whether to perform handoff from the cellular network to the portable Internet/WLAN and registers a location of the wireless terminal in the portable Internet/WLAN, sends a request for handoff to the cellular network, receives a request for voice-over-Internet protocol (VoIP) call setup through the portable Internet/WLAN, sets up the VoIP call to the portable Internet/WLAN, and releases resources of a circuit voice call to the cellular network.

21. A system for mobile terminal communication comprising:
a cellular network
a portable Internet/wireless local area network (WLAN); and
a wireless terminal;
wherein whether the wireless terminal has entered the cellular network is determined, a location of the wireless terminal in the cellular network according to the determination result is registered, a request for handoff is sent to the portable Internet/WLAN, and the portable Internet/WLAN sets up a circuit voice call of the mobile terminal to the cellular network.
